(19) United States
(12) Patent Application Publication
(10) Pub. No.: US 2010/0190084 A1
(43) Pub. Date: Jul. 29, 2010

(54) SINGLE FUEL CELL

(75) Inventors: Fumishige Shizuku, Komaki-shi (JP); Hiroshi Nishiyama, Okazaki-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI, AICHI-KEN (JP)

(21) Appl. No.: 12/670,474

(22) PCT Filed: Nov. 28, 2008
(86) PCT No.: PCT/JP2008/071701

§ 371 Date: Mar. 11, 2010

(30) Foreign Application Priority Data
Nov. 28, 2007 (JP) 2007-307593
Nov. 28, 2007 (JP) 2007-307734

(51) Int. Cl. H01M 8/10; H01M 8/06

(52) U.S. Cl. 429/480

(57) ABSTRACT

A single fuel cell which can suppress mechanical load applied to the electrolyte membrane of the same and apply a sufficient load per unit area of the central region of the same. The single fuel cell comprises a membrane electrode assembly, and a single fuel cell thickness control layer which is thinner in a region of the single fuel cell where a second part of a protective layer is present than in a central region of the single fuel cell where the protective layer is not present, or is not present in the region where the second part of the protective layer is present so that the thickness of the single fuel cell in the region where the second part of the protective layer is present is equal to or smaller than the thickness of the same in the central region where the protective layer is not present.

### TECHNICAL FIELD

The present invention relates to a single fuel cell.

### BACKGROUND ART

A fuel cell converts chemical energy directly to electrical energy by supplying a fuel and an oxidant to two electrically-connected electrodes and causing electrochemical oxidation of the fuel. Unlike thermal power generation, fuel cells are not limited by Carnot cycle, so that they can show high energy conversion efficiency. In general, a fuel cell is formed by stacking a plurality of single fuel cells each of which has a membrane electrode assembly as a fundamental structure, in which an electrolyte membrane is sandwiched between a pair of electrodes. Especially, a solid polymer electrolyte fuel cell which uses a solid polymer electrolyte membrane as the electrolyte membrane is attracting attention as a portable and mobile power source because it has such advantages that it can be downsized easily, operate at low temperature, etc.

In a solid polymer electrolyte fuel cell, the reaction represented by the following formula (1) proceeds at an anode (fuel electrode) in the case of using hydrogen as fuel:

H₂→2H⁺+2e⁻ Formula (1)

Electrons generated by the reaction represented by the formula (1) pass through an external circuit, work by an external load, and then reach a cathode (oxidant electrode). Protons generated by the reaction represented by the formula (1) are, in the state of being hydrated and by electro-osmosis, transferred from the anode side to the cathode side through the solid polymer electrolyte membrane.

In the case of using oxygen as an oxidant, the reaction represented by the following formula (2) proceeds at the cathode:

2H⁺+(½)O₂+2e⁻→H₂O Formula (2)

Water produced at the cathode passes through a gas diffusion layer and is discharged to the outside. Accordingly, fuel cells are clean power source that produces no emissions except water.

In a solid polymer electrolyte fuel cell, normally, a fuel and an oxidant are continuously supplied to the fuel cell in the gaseous state (in the state of fuel gas and oxidant gas). These gases are led to a three-phase interface in which catalyst particles supported by carriers, which are conductors, are in contact with a polymer electrolyte that ensure ion-conductive paths, thereby promoting the above reaction. Accordingly, it is known that in general, an electrode which comprises a porous catalyst layer formed by a uniform mixture of catalyst particles with a polymer electrolyte is used as the electrode of fuel cells.

FIG. 21s are views that show a general solid polymer electrolyte single fuel cell 100, and they are also views that schematically show a cross-section of the same in its layer stacking direction. The single fuel cell 100 comprises a membrane electrode assembly 8 which comprises a hydrogen ion-conductive solid polymer electrolyte membrane (hereinafter may be simply referred to as electrolyte membrane) 1 and a pair of a cathode electrode 6 and an anode electrode 7 between which the electrolyte membrane is sandwiched; moreover, the single fuel cell 100 comprises a pair of separators 9 and 10 between which the membrane electrode assembly 8 is sandwiched so that the electrodes are sandwiched from the outside. Gas passages 11 and 12 are each provided at the boundary of the separator and electrode. Hydrogen gas is continuously supplied at the anode side, and oxygen-containing gas (normally air) is continuously supplied at the cathode side. In general, as the electrode, one which comprises a catalyst layer and a gas diffusion layer in this order from closest to the electrolyte membrane is used. That is, the cathode electrode 6 comprises one which comprises a cathode catalyst layer 2 and a gas diffusion layer 4, and the anode electrode 7 comprises one which comprises an anode catalyst layer 3 and a gas diffusion layer 5.

As shown in FIG. 21(a), a water-repellent layer is normally provided on a surface of the gas diffusion layer which faces the catalyst layer. More specifically, a water-repellent layer 13 and a water-repellent layer 14 are provided between the cathode catalyst layer 2 and the gas diffusion layer 4, and between the anode catalyst layer 3 and the gas diffusion layer 5, respectively. In general, the water-repellent layer has a porous structure which comprises, for example, electroconductive particles such as carbon particles and carbon fibers, and a water-repellent resin such as polytetrafluoroethylene (PTFE). The water-repellent layer can increase the drainage properties of the gas diffusion layer while it can maintain the water content in the catalyst layer and electrolyte membrane at an appropriate level; moreover, it is advantageous in improving the electrical contact between the catalyst layer and the gas diffusion layer.

As shown in FIG. 21(b), a single fuel cell which does not comprise the above-mentioned water-repellent layer is known.

The electrolyte membrane 1 sandwiched between a pair of the electrodes is normally formed to be larger than an electrode area which is actually used to generate electricity, specifically the area of the catalyst layers 2 and 3. In this case, the edge portion of the electrolyte membrane is weak, on which no catalyst layer is applied. In particular, as shown in FIG. 22(a), fragments and projections 15 which arise from a carbon or metallic porous body that forms the gas diffusion layers 4 and 5, penetrate the water-repellent layers 13 and 14, thereby sticking in the electrolyte membrane 1. Also as shown in FIG. 22(b), the fragments and projections 15 directly stick in the electrolyte membrane 1. The electrolyte membrane 1 is thus broken and causes a short circuit, etc., resulting in a problem of decreased initial voltage, for example.

For solving such a problem, as disclosed in Patent Literature 1 for example, a technique is known which reinforce a membrane-catalyst layer assembly by providing a reinforcing layer on the edge portion of the membrane-catalyst layer assembly.

Patent Literature 1: Japanese Patent Application Laid-Open (JP-A) No. 2004-47230

### SUMMARY OF INVENTION

### Technical Problem

FIG. 23s are views that show a single fuel cell 200 of the prior art which comprises a reinforcing layer, and they are also views that schematically show a cross-section of the same in its layer stacking direction. FIG. 23(a) shows a single fuel cell which comprises water-repellent layers 13 and 14, and FIG. 23(b) shows a single fuel cell that does not comprise the water-repellent layers.

It is technically difficult to provide a reinforcing layer at a first part 16a only that is present between the outer peripheral edge portion of the polymer electrolyte membrane 1 and that of the gas diffusion layer 4 or 5 which face each other. As shown in FIG. 23s, therefore, a reinforcing layer is actually also provided at a second part 16b that overlaps the outer periphery of the anode or cathode catalyst layer. Because of this, a thickness 17b of the single fuel cell in the region where the second part 16b of the reinforcing layer is present is larger than a thickness 17c of the single fuel cell in a central region of the same where the reinforcing layer is not present, so that when applying a constant load to the single fuel cell, the load per unit area is larger in the region where the second part 16b of the reinforcing layer is present than in the central region of the single fuel cell.

Also, a thickness 17a of the single fuel cell in the region where the first part 16a of the reinforcing layer is present is larger than the thickness 17c when the thickness of a reinforcing layer 16 is larger than that of a catalyst layer 2 or catalyst layer 3, so that when applying a constant load to the single fuel cell, the load per unit area is larger in the region where the first part 16a of the reinforcing layer is present than in the central region of the single fuel cell.

Consequently, when a plurality of the single fuel cells are stacked to generate electricity, the load per unit area that is applied to the outer peripheral edge portion of the single fuel cell is increased, which causes a problem of increased mechanical load applied to the electrolyte membrane. In addition, the load applied per unit area of the central region of the single fuel cell, which plays a key role in generating electricity, is not sufficient, so that there is another problem in which generation of sufficient electricity as designed is not possible.

The present invention is to provide a single fuel cell which can generate sufficient electricity as designed by suppressing the mechanical load that is applied to the electrolyte membrane and applying a sufficient load per unit area of the central region of the single fuel cell, and a method for producing the same.

### Solution to Problem

The single fuel cell of the present invention is a single fuel cell which comprises a membrane electrode assembly and a pair of separators, in which assembly an anode electrode that comprises an anode catalyst layer and a gas diffusion layer is provided on a first surface of a solid polymer electrolyte membrane, and a cathode electrode that comprises a cathode catalyst layer and a gas diffusion layer is provided on a second surface of the solid polymer electrolyte membrane, wherein, on at least one of the anode and cathode sides of the solid polymer electrolyte membrane, the anode or cathode catalyst layer has a size and shape that are slightly smaller than those of the solid polymer electrolyte membrane and those of the gas diffusion layer, and an outer peripheral edge portion of the solid polymer electrolyte membrane and that of the gas diffusion layer stick out of an outer periphery of the anode or cathode catalyst layer and face each other; wherein a frame-shaped protective layer is provided on at least one of the anode and cathode sides of the solid polymer electrolyte membrane, which has a first part that is present between the outer peripheral edge portion of the electrolyte membrane and that of the gas diffusion layer which face each other, and a second part that overlaps the outer periphery of the anode or cathode catalyst layer; and wherein the single fuel cell comprises a single fuel cell thickness control layer which is thinner in a region of the single fuel cell where the second part of the protective layer is present than in a central region of the single fuel cell where the protective layer is not present, or is not present in the region where the second part of the protective layer is present so that the thickness of the single fuel cell in the region where the second part of the protective layer is present is equal to or smaller than the thickness of the same in the central region where the protective layer is not present.

In the single fuel cell having such a configuration, to make the thickness of the single fuel cell in the region where the second part of the protective layer is present, which is such thick due to the presence of the protective layer, equal to or smaller than the thickness of the same in the central region where the protective layer is not present, the thickness of the single fuel cell thickness control layer in the region where the second part is present is thinner than the thickness of the same in the central region, or the single fuel cell thickness control layer is not provided in the region where the second part is present. Because of this, when a plurality of the single fuel cells are stacked, the mechanical load applied to the electrolyte membrane can be suppressed, and a sufficient load is applied per unit area of the central region of the single fuel cell, thereby generating sufficient electricity as designed.

In an embodiment of the single fuel cell of the present invention, the single fuel cell thickness control layer is a water-repellent layer that is present between the anode or cathode catalyst layer and the gas diffusion layer.

In the single fuel cell having such a configuration, to make the thickness of the single fuel cell in the region where the second part of the protective layer is present, which is such thick due to the presence of the protective layer, equal to or smaller than the thickness of the same in the central region where the protective layer is not present, the thickness of the water-repellent layer, which is essentially unnecessary in the region where the second part is present, is thinner in the region where the second part is present than in the central region, or the water-repellent layer is not provided in the region where the second part is present. Because of this, when a plurality of the single fuel cells are stacked, the mechanical load applied to the electrolyte membrane can be suppressed, and a sufficient load is applied per unit area of the central region of the single fuel cell, thereby generating sufficient electricity as designed.

In an embodiment of the single fuel cell of the present invention, the single fuel cell thickness control layer is at least one of porous layers between which the membrane electrode assembly is sandwiched, and the resulting sandwich is further sandwiched between a pair of flat separators each of which has no gas passage.

The single fuel cell having such a configuration employs a structure in which the flat separators having no gas passage are used, and gas is supplied from the porous layers that are in contact with the flat separators and disposed more inside of the single fuel cell than the flat separators; therefore, a pressure that is applied to the membrane electrode assembly inside the single fuel cell can be constant due to the elasticity of the porous layer. Also, to make the thickness of the single fuel cell in the region where the second part of the protective layer is present, which is such thick due to the presence of the protective layer, equal to or smaller than the thickness of the same in the central region where the protective layer is not present, the thickness of the porous layer is thinner in the region where the second part is present than in the central region. Because of this, when a plurality of the single fuel cells are stacked, the mechanical load applied to the electrolyte membrane can be suppressed, and a sufficient load is applied per unit area of the central region of the single fuel cell, thereby generating sufficient electricity as designed.

In the single fuel cell of the present invention, it is preferable that on both of the anode and cathode sides of the solid polymer electrolyte membrane, the single fuel cell thickness control layer is thinner in the region of the single fuel cell where the second part of the protective layer is present than in the central region of the same where the protective layer is not present, or is not present in the region where the second part of the protective layer is present so that the thickness of the single fuel cell in the region where the second part of the protective layer is present is equal to or smaller than the thickness of the same in the central region where the protective layer is not present.

In the single fuel cell having such a configuration, on both of the anode and cathode sides, the mechanical load applied to the electrolyte membrane can be suppressed, and a sufficient load is applied per unit area of the central region of the single fuel cell.

In the single fuel cell of the present invention, it is preferable that on at least one of the anode and cathode sides of the solid polymer electrolyte membrane, the single fuel cell thickness control layer is thinner in the region of the single fuel cell where the first and second parts of the protective layer are present than in the central region of the same where the protective layer is not present, or is not present in the region where the first and second parts of the protective layer are present so that the thickness of the single fuel cell in the region where the first and second parts of the protective layer are present is equal to or smaller than the thickness of the same in the central region where the protective layer is not present.

In the single fuel cell having such a configuration, the thickness of the single fuel cell thickness control layer in the region where the second part is present is controlled, and to make the thickness of the single fuel cell in the region where the first part of the protective layer is present, which is such thick due to the presence of the protective layer, equal to or smaller than the thickness of the same in the central region where the protective layer is not present, the thickness of the single fuel cell thickness control layer is thinner in the region where the first part is present than in the central region, or the single fuel cell thickness control layer is not provided in the region where the first part is present. Because of this, when a plurality of the single fuel cells are stacked, the mechanical load applied to the electrolyte membrane can be suppressed, and a sufficient load is applied per unit area of the central region of the single fuel cell, thereby generating sufficient electricity as designed.

In the single fuel cell of the present invention, it is preferable that when the single fuel cell thickness control layer is the water-repellent layer, the membrane electrode assembly is sandwiched between a pair of porous layers, and the resulting sandwich is further sandwiched between a pair of flat separators each of which has no gas passage.

For example, unlike the case of using a separator with a groove-like passage that the presence of the groove-like passage causes variations in load per unit area, in the single fuel cell having such a configuration, by using the flat separators having no gas passage, a sufficient load can be applied per unit area of the whole separators. Also, it is possible to reduce costs for forming a groove-like passage that are necessary to produce a separator with a groove-like passage. Furthermore, it is possible to increase the gas supplying ability by disposing the porous layer between the membrane electrode assembly and the flat separator.

In the single fuel cell of the present invention, each of the porous layers preferably has a porosity of 70% or more and a pore diameter of 20 to 100 nm.

In the single fuel cell having such a configuration, because the porous layer has a sufficient porosity and pore diameter, a sufficient amount of fuel gas and oxidant gas can be supplied when producing electricity.

In the single fuel cell of the present invention, it is preferable that when the single fuel cell thickness control layer is the water-repellent layer, the thickness of the water-repellent layer in the region of the single fuel cell where the first and second parts of the protective layer are present is equal to or smaller than the thickness of the protective layer.

In the single fuel cell having such a configuration, by selecting en appropriate thickness of the water-repellent layer in the region where the first and second parts of the protective layer are present, the mechanical load applied to the electrolyte membrane can be suppressed, and a sufficient load is applied per unit area of the central region of the single fuel cell.

In the single fuel cell of the present invention, it is preferable that when the single fuel cell thickness control layer is the water-repellent layer, the water-repellent layer is not present in the region of the single fuel cell where the first and second parts of the protective layer are present.

In the single fuel cell having such a configuration, by providing no water-repellent layer at the outer edge portion of the anode or cathode catalyst layer, which is essentially unnecessary at the outer edge portion, the mechanical load applied to the electrolyte membrane can be suppressed, and a sufficient load is applied per unit area of the central region of the single fuel cell.

In the single fuel cell of the present invention, the thickness of the porous layer is preferably 200 to 600 μm in the region where the first and second parts of the protective layer are present.

In the single fuel cell having such a configuration, the porous layer can have a thickness which keep elasticity that is sufficient to make the pressure applied to the membrane electrode assembly inside the single fuel cell constant.

The method for producing a single fuel cell according to the present invention is a method for producing the above-mentioned single fuel cell of the present invention, which comprises a step of partially and selectively decreasing the thickness of at least one of the porous layers provided on the anode and cathode sides of the solid polymer electrolyte membrane by shaving or pressing a part of the porous layer which overlaps the region where the first and second parts of the protective layer are present.

The single fuel cell of the present invention can be obtained by using the method for producing the single fuel cell having such a step. Also, it is possible to decrease the thickness of the porous layer in at least one of the region where the first part of the protective layer is present and the region where the second part of the same is present by a simple method of shaving or pressing the porous layer in the region where the first and second parts of the protective layer are present.

### Advantageous Effects of Invention

In the present invention, to make the thickness of the single fuel cell in the region where the second part of the protective layer is present, which is such thick due to the presence of the protective layer, equal to or smaller than the thickness of the same in the central region where the protective layer is not present, the thickness of the single fuel cell thickness control layer is thinner in the region where the second part is present than in the central region, or the single fuel cell thickness control layer is not provided in the region where the second part is present. Because of this, when a plurality of the single fuel cells are stacked, the mechanical load applied to the electrolyte membrane can be suppressed, and a sufficient load is applied per unit area of the central region of the single fuel cell, thereby generating sufficient electricity as designed.

### BRIEF DESCRIPTION OF DRAWINGS

FIG. 1s are schematic cross sections showing an example of the positional relationship between an electrolyte membrane, a catalyst layer and a protective layer.

FIG. 2 is a schematic cross section showing a typical example the membrane electrode assembly according to the present invention, in which a single fuel cell thickness control layer is a water-repellent layer, and an electrode is provided only on one surface of an electrolyte membrane.

FIG. 3 is a schematic cross section showing a second typical example of the membrane electrode assembly according to the present invention, in which a single fuel cell thickness control layer is a water-repellent layer, and an electrode is provided only on one surface of an electrolyte membrane.

FIG. 4 is a schematic cross section showing a third typical example of the membrane electrode assembly according to the present invention, in which a single fuel cell thickness control layer is a water-repellent layer, and an electrode is provided only on one surface of an electrolyte membrane.

FIG. 5 is a schematic cross section showing a typical example in which a single fuel cell thickness control layer is a porous layer, and an electrode and the porous layer are provided only on one surface of an electrolyte membrane.

FIG. 6 is a schematic cross section showing a second typical example in which a single fuel cell thickness control layer is a porous layer, and an electrode and the porous layer are provided only on one surface of an electrolyte membrane.

FIG. 7s are schematic cross sections showing a membrane electrode assembly in which water-repellent layer thickness control shown in FIG. 2 is applied to the examples shown in FIG. 1s.

FIG. 8s are schematic cross sections showing a membrane electrode assembly in which water-repellent layer thickness control shown in FIG. 2 is applied to the examples shown in FIG. 1s.

FIG. 9s are schematic cross sections showing a membrane electrode assembly in which water-repellent layer thickness control shown in FIG. 3 is applied to the examples shown in FIG. 1s.

FIG. 10s are schematic cross sections showing a membrane electrode assembly in which water-repellent layer thickness control shown in FIG. 3 is applied to the examples shown in FIG. 1s.

FIG. 11s are schematic cross sections showing a membrane electrode assembly in which water-repellent layer thickness control shown in FIG. 4 is applied to the example shown in FIG. 1s.

FIG. 12s are schematic cross sections showing a membrane electrode assembly in which water-repellent layer thickness control shown in FIG. 4 is applied to the examples shown in FIG. 1s.

FIG. 13s are schematic cross sections showing a laminate in which porous layer thickness control shown in FIG. 5 is applied to the examples shown in FIG. 1s.

FIG. 14s are schematic cross sections showing a laminate in which porous layer thickness control shown in FIG. 5 is applied to the examples shown in FIG. 1s.

FIG. 15s are schematic cross sections showing a laminate in which porous layer thickness control shown in FIG. 6 is applied to the examples shown in FIG. 1s.

FIG. 16s are schematic cross sections showing a laminate in which porous layer thickness control shown in FIG. 6 is applied to the examples shown in FIG. 1s.

FIG. 17 is a view showing a typical example of the single fuel cell according to the present invention.

FIG. 18 is a view showing a second typical example of the single fuel cell according to the present invention.

FIG. 19 is a view showing a third typical example of the single fuel cell according to the present invention.

FIG. 20 is a view showing a fourth typical example of the single fuel cell according to the present invention.

FIG. 21s are views schematically showing a cross section of a general solid polymer electrolyte single fuel cell 100 in its layer stacking direction.

FIG. 22s are views showing a frame format of a general solid polymer electrolyte single fuel cell 100 in which fragments and projections 15 stick in an electrolyte membrane 1.

FIG. 23s are views schematically showing a cross section of a single fuel cell 200 of the prior art in its layer stacking direction, which is provided with a reinforcing layer

### REFERENCE SIGNS LIST

1. Solid polymer electrolyte membrane
2. Cathode catalyst layer
3. Anode catalyst layer
4 and 5. Gas diffusion layer
6. Cathode electrode
7. Anode electrode
8. Membrane electrode assembly
9 and 10. Separator
11 and 12. Gas passage
13 and 14. Water-repellent layer
15. Fragment and projection
16. Reinforcing layer
16a. First part of the reinforcing layer
16b. Second part of the reinforcing layer
17a. Thickness of the single fuel cell in the region where the first part 16a of the reinforcing layer is present
17b. Thickness of the single fuel cell in the region where the second part 16b of the reinforcing layer is present
17c. Thickness of the central region of the single fuel cell where the reinforcing layer is not present
21. Solid polymer electrolyte membrane
22. Catalyst layer
23. Protective layer
23a. First part of protective layer
23b. Second part of protective layer
24. Water-repellent layer
24a. Water-repellent layer thickness in the region where the first part 23a of the protective layer is present
24b. Water-repellent layer thickness in the region where the second part 23b of the protective layer is present
24c. Water-repellent layer thickness in the central region where the protective layer is not present
25. Gas diffusion layer
26a. Membrane electrode assembly thickness in the region where the first part 23a of the protective layer is present
26b. Membrane electrode assembly thickness in the region where the second part 23b of the protective layer is present
26c. Membrane electrode assembly thickness in the central region where the protective layer is not present
27. Porous layer
27a. Thickness of the porous layer 27 in the region where the first part 23a of the protective layer is present
27b. Thickness of the porous layer 27 in the region where the second part 23b of the protective layer is present
27c. Thickness of the porous layer 27 in the central region
28a. Thickness of a laminate in the region where the first part 23a of the protective layer is present
28b. Thickness of a laminate in the region where the second part 23b of the protective layer is present
28c. Laminate thickness in the central region
29. Flat separator
30a. Thickness of the single fuel cell in the region where the first part 23a of the protective layer is present
30b. Thickness of the single fuel cell in the region where the second part 23b of the protective layer is present
30c. Thickness of the single fuel cell in the central region where the protective layer is not present
100. Single fuel cell
200. Single fuel cell provided with the reinforcing layer

### Description of Embodiments

The single fuel cell of the present invention is a single fuel cell which comprises a membrane electrode assembly and a pair of separators, in which assembly an anode electrode that comprises an anode catalyst layer and a gas diffusion layer is provided on a first surface of a solid polymer electrolyte membrane, and a cathode electrode that comprises a cathode catalyst layer and a gas diffusion layer is provided on a second surface of the solid polymer electrolyte membrane, wherein, on at least one of the anode and cathode sides of the solid polymer electrolyte membrane, the anode or cathode catalyst layer has a size and shape that are slightly smaller than those of the solid polymer electrolyte membrane and those of the gas diffusion layer, and an outer peripheral edge portion of the solid polymer electrolyte membrane and that of the gas diffusion layer stick out of an outer periphery of the anode or cathode catalyst layer and face each other; wherein a frame-shaped protective layer is provided on at least one of the anode and cathode sides of the solid polymer electrolyte membrane, which has a first part that is present between the outer peripheral edge portion of the electrolyte membrane and that of the gas diffusion layer which face each other, and a second part that overlaps the outer periphery of the anode or cathode catalyst layer; and wherein the single fuel cell comprises a single fuel cell thickness control layer which is thinner in a region of the single fuel cell where the second part of the protective layer is present than in a central region of the single fuel cell where the protective layer is not present, or is not present in the region where the second part of the protective layer is present so that the thickness of the single fuel cell in the region where the second part of the protective layer is present is equal to or smaller than the thickness of the same in the central region where the protective layer is not present.

In an embodiment of the single fuel cell of the present invention, the single fuel cell thickness control layer is a water-repellent layer that is present between the anode or cathode catalyst layer and the gas diffusion layer.

In other embodiment of the single fuel cell of the present invention, the single fuel cell thickness control layer is at least one of porous layers between which the membrane electrode assembly is sandwiched, and the resulting sandwich is further sandwiched between a pair of flat separators each of which has no gas passage.

In the present invention, from the viewpoint of design and production, the solid polymer electrolyte membrane, the anode and cathode catalyst layers, the gas diffusion layer, the protective layer and the separators have a thickness that is substantially uniform thoroughly, and only the single fuel cell thickness control layer is subjected to control of its thickness according to the regions of the single fuel cell. Also, the solid polymer electrolyte membrane, the anode and cathode catalyst layers, the gas diffusion layer, the protective layer and the separators are thoroughly continuous.

In the present invention, the single fuel cell thickness control layer is a layer such that it can make the thickness of the outer edge portion of the single fuel cell, which is increased in the prior art by providing a protective layer at the outer edge portion of a single fuel cell, smaller than that of the central part of the single fuel cell by changing the thickness of the single fuel cell thickness control layer itself partly according to the parts of the single fuel cell. By changing the thickness of the single fuel cell in this way, when a plurality of the single fuel cells are stacked, the mechanical load applied to the electrolyte membrane can be suppressed, and a sufficient load is applied per unit area of the central region of the single fuel cell, thereby generating sufficient electricity as designed.

In addition to a layer that is inside the single fuel cell and contributes directly or indirectly to the generation of electricity, the single fuel cell thickness control layer can be added as a new layer. It is preferable to use a layer that is inside the single fuel cell and contributes directly or indirectly to the generation of electricity, however, as the single fuel cell thickness control layer. More specifically, it is preferable to control the entire thickness of the single fuel cell by partly shaving or pressing the layer that is inside the single fuel cell and contributes directly or indirectly to the generation of electricity to an extent that does not affect the generation of electricity, or by decreasing the area of the layer to the same extent.

As the single fuel cell thickness control layer, specifically, there may be mentioned a water-repellent layer, porous layer, and so on that will be described below.

It is not necessarily that only one kind of single fuel cell thickness control layer is provided inside one single fuel cell. Various kinds of single fuel cell thickness control layers can be provided inside one single fuel cell. In the case of providing various kinds of single fuel cell thickness control layers like this, each of the layers can be arranged independently so as to produce the advantageous effects of the present invention, or these layers can be arranged so as to produce the advantageous effects of the present invention in combination.

The polymer electrolyte membrane is a polymer electrolyte membrane which is used in fuel cells, and there may be mentioned fluorinated polymer electrolyte membranes which contain a fluorinated polymer electrolyte such as perfluorocarbon sulfonic acid resin, as typified by Nafion (product name); moreover, for example, there may be mentioned hydrocarbon polymer electrolyte membranes which comprise a hydrocarbon polymer electrolyte in which protonic acid groups (proton conducting groups) such as sulfonic acid groups, carboxylic acid groups, phosphoric acid groups and boronic acid groups are introduced to a hydrocarbon polymer such as an engineering plastic, examples of which include polyether ether ketone, polyether ketone, polyethersulfone, polyphenylene sulfide, polyphenylene ether, polyparaphenylene and so on, or a commodity plastic, examples of which include polyethylene, polypropylene, polystyrene and so on.

The catalyst layer can be formed by using a catalyst ink which contains a catalyst, an electroconductive material and a polymer electrolyte.

As the catalyst, a catalyst in which a catalytic component(s) is supported by an electroconductive particle(s) is generally used. As the catalytic component, one which is generally used for solid polymer fuel cells can be used without particular limitation, as long as it has catalyst activity for oxidation reaction of a fuel at the fuel electrode or reduction reaction of an oxidant at the oxidant electrode. For example, platinum and alloys of platinum and metals such as ruthenium, iron, nickel, manganese, cobalt and copper can be used.

As the electroconductive particle being a catalyst carrier, electroconductive carbon materials including carbon particles such as carbon black and carbon fibers, and metallic materials such as metallic particles and metallic fibers can be used. The electroconductive material also functions as an electroconductive material which provides the catalyst layer with electroconductivity.

A method for forming the catalyst layer is not particularly limited. For example, the catalyst layer can be formed on the surface of a gas diffusion layer sheet by applying the catalyst ink to the surface of the gas diffusion layer sheet and drying the same, or the catalyst layer can be formed on the surface of the electrolyte membrane by applying the catalyst ink to the surface of the electrolyte membrane and drying the same. Alternatively, the catalyst layer can be formed on the surface of the electrolyte membrane or of the gas diffusion layer sheet in such a manner that the catalyst ink is applied to the surface of a transfer substrate and dried to produce a transfer sheet; the transfer sheet is attached to the electrolyte membrane or the gas diffusion sheet by hot pressing or the like; thereafter, a substrate film is removed from the transfer sheet.

The catalyst ink can be obtained by dissolving or dispersing a catalyst and an electrolyte for electrodes as mentioned above in a solvent. The solvent of the catalyst ink can be appropriately selected, and examples of which include alcohols such as methanol, ethanol and propanol, organic solvents such as N-methyl-2-pyrolidone (NMP) and dimethyl sulfoxide (DMSO), mixtures of the organic solvents, and mixtures of the organic solvents and water. The catalyst ink can contain other components as needed, such as a binder and a water-repellent resin, besides the catalyst and the electrolyte.

A method for applying the catalyst ink, a method for drying the same, etc., can be appropriately selected. As the method for applying the catalyst ink, for example, there may be mentioned spraying methods, screen printing methods, doctor blade methods, gravure printing methods and die-coating methods. As the method for drying the same, for example, there may be mentioned drying under reduced pressure, drying by heating, and drying by heating under reduced pressure. There is no limitation imposed on specific conditions for drying under reduced pressure and drying by heating, so that they can be determined appropriately.

The application amount of the catalyst ink depends on the composition of the catalyst ink and the catalytic performance of a catalytic metal that is used for an electrode catalyst, for example. The amount of the catalytic component per unit area can be about 0.01 to 2.0 mg/cm². The thickness of the catalyst layer is not particularly limited and can be about 1 to 50 μm.

A frame-shaped protective layer can be formed before, when or after the catalyst layer is formed on the electrolyte membrane.

The protective layer can be a layer having a thickness of 5 to 100 μm. As the material, there may be used rubbers such as silicon rubber, EPDM, SBR rubber and fluoro rubber; and fluorinated polymer electrolyte membranes which contain a fluorinated polymer electrolyte such as perfluorocarbon sulfonic acid resin, as typified by Nafion (product name). In addition, there may be used PEN films, PTFE, PET, polyimide films, polypropylene film, etc.

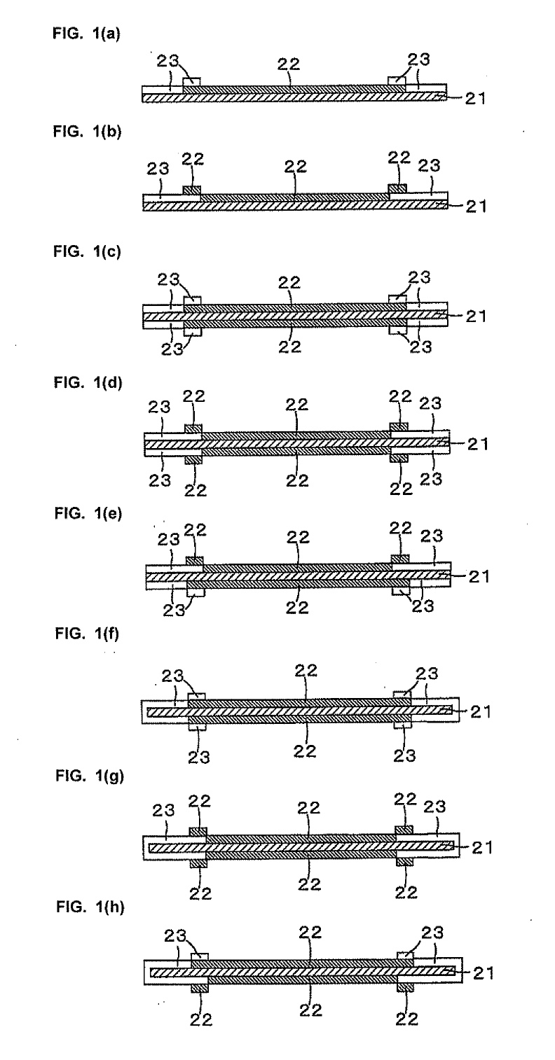

FIG. 1 is a schematic cross section showing an example of the positional relationship between the electrolyte membrane, the catalyst layer and the protective layer. In this view, a catalyst layer 22 and a protective layer 23 are each shown intermittently to clarify the relationship; however, layers which are identical in pattern are actually one continuous layer. Actually, the protective layers 23 which are shown on both the right and left sides of the view has a frame shape that surrounds the outer periphery of the catalyst layer 22, so that they also form one continuous layer. It is technically difficult to provide the protective layer 23 only in the region where the outer peripheral edge portion of a polymer electrolyte membrane 21 is present; therefore, in fact, the inner peripheral edge portion of the protective layer 23 is provided overlapping the outer periphery of the catalyst layer 22.

FIGS. 1(a) and 1(b) are views showing an example in which the catalyst layer 22 and the protective layer 23 are provided on one surface of the electrolyte membrane 21. There are two orders in which the catalyst layer and the protective layer are provided: (a) the catalyst layer 22 is provided on one surface of the electrolyte membrane 21; thereafter, the protective layer 23 is formed thereon; and (b) the protective layer 23 is provided on one surface of the electrolyte membrane 21; thereafter, the catalyst layer 22 is formed thereon. In both cases, a part is thus provided where the catalyst layer 22 and the protective layer 23 overlap each other.

FIGS. 1(c) to 1(e) are views showing an example in which the catalyst layer 22 and the protective layer 23 are provided on both surfaces of the electrolyte membrane 21. There are three orders in which the catalyst layer and the protective layer are provided: (c) the catalyst layer 22 is provided on both surfaces of the electrolyte membrane 21 each; thereafter, the protective layer 23 is formed on both surfaces each; (d) the protective layer 23 is provided on both surfaces of the electrolyte membrane 21 each; thereafter, the catalyst layer 22 is formed on both surfaces each; and (e) the catalyst layer 22 and the protective layer 23 are formed on one surface of the electrolyte membrane 21 in the order (a) and also on the other surface in the order (b).

As shown in FIGS. (f) to (h), the protective layer 23 can have a structure in which it is continuous on both surfaces because it has insulation properties and is not involve in electric generation. More specifically, there are the following three ways: (f) the catalyst layer 22 is provided on both surfaces of the electrolyte membrane 21 each; thereafter, the protective layer 23 which is continuous on both surfaces is formed; (g) the protective layer 23 which is continuous on both surfaces of the electrolyte membrane 21 is provided; thereafter, the catalyst layer 22 is formed on both surfaces each; and (h) the catalyst layer 22 is provided on one surface of the electrolyte membrane 21; thereafter, the protective layer 23 which is continuous on both surfaces is formed, and then the catalyst layer 22 is provided on the other surface.

As described in the above-mentioned method for forming the catalyst layer, there is the method for forming the catalyst layer on the surface of the gas diffusion layer sheet, and so on. In the case of using such methods, the positional relationship between the electrolyte membrane, the catalyst layer and the protective layer can result in any of the above FIGS. (a) to (h).

As the gas diffusion layer sheet which forms the gas diffusion layer, there may be mentioned one that constituted by an electroconductive porous body which has gas diffusivity that is sufficient to supply gas efficiently to the catalyst layer, electroconductivity, and strength that is required for the material constituting the gas diffusion layer to have. Examples of the electroconductive porous body include carbonaceous porous bodies such as carbon paper, carbon cloth and carbon felt, and metallic mesh or metallic porous bodies comprising metals such as titanium, aluminum, copper, nickel, nickel chrome alloys, copper, copper alloys, silver, aluminum alloys, zinc alloys, lead alloys, titanium, niobium, tantalum, iron, stainless, gold and platinum. The thickness of the electroconductive porous body is preferably about 50 to 500 μm.

The gas diffusion layer sheet can be formed of a single layer of the conductive porous body as mentioned above. Alternatively, the sheet can be such that a water-repellent layer is provided on a surface thereof which faces the catalyst layer. In general, the water-repellent layer has a porous structure which comprises, for example, electroconductive particles such as carbon particles and carbon fibers, and a water-repellent resin such as polytetrafluoroethylene (PTFE). The water-repellent layer can increase the drainage properties of the gas diffusion layer while it can maintain the water content in the catalyst layer and electrolyte membrane at an appropriate level; moreover, it is advantageous in improving the electrical contact between the catalyst layer and the gas diffusion layer.

A method for forming the water-repellent layer on the electroconductive porous body is not particularly limited. For example, it is possible that a water-repellent layer ink prepared by mixing electroconductive particles such as carbon particles, a water-repellent resin and, as needed, other components with a solvent that is an organic solvent such as ethanol, propanol and propylene glycol, water or a mixture thereof, is applied at least to the surface of the conductive porous body which faces the catalyst layer, and then dried and/or baked. In general, the thickness of the water-repellent layer can be about 1 to 50 μm. Examples of the method for applying the water-repellent layer ink to the electroconductive porous body include screen printing methods, spraying methods, doctor blade methods, gravure printing methods and die-coating methods.

Also in the electroconductive porous body, by coating and impregnating the catalyst layer-facing surface with a water-repellent resin such as polytetrafluoroethylene using a bar coater or the like, the electroconductive porous body can be processed so that moisture in the catalyst layer is efficiently discharged to the outside of the gas diffusion layer.

The electrolyte membrane and gas diffusion layer sheet at least one of which has the catalyst layer formed by the above method are appropriately stacked and attached to each other by hot-pressing or the like, thereby obtaining a membrane electrode assembly.

The thus-produced membrane electrode assembly is further sandwiched between separators to form a single fuel cell. As the separators, one which has electroconductive and gas sealing properties and can function as a collector and gas sealer can be used, such as carbon separators made of carbon/resin composites which contain a high concentration of carbon fibers and metallic separators comprising metallic materials. Examples of the metallic separators include separators made of metallic materials having excellent corrosion-resistance and separators on which surface coating is performed for increasing the corrosion resistance by coating the surface with carbon or a metallic material that has excellent corrosion-resistance.

It is preferable that the above-mentioned membrane electrode assembly is sandwiched between a pair of porous layers, and the resulting sandwich is further sandwiched between a pair of flat separators each of which has no gas passage to form the single fuel cell.

As the porous layer, for example, there may be used a sintered foam of titanium, nickel or the like because it plays a role in gas diffusion, electron conduction and absorption and drainage of water upon electrical generation. Such foams are advantageous in that they have high rigidity and thus can maintain gas diffusivity even under a high surface pressure, so that they can apply a constant load all over the surface compared with separators having a gas passage. As the porous layer used herein, it is preferable to use a sintered foam of titanium having a porosity of 60% or more, a pore diameter of 10 to 1000 nm, and a thickness of 50 to 500 μm. This is because since the porous layer has a sufficient porosity and pore diameter, it can supply a sufficient amount of fuel gas and oxidant gas upon electrical generation. It is more preferable that the porosity is 70% or more, and the pore diameter is 20 to 100 nm; moreover, it is most preferable that the porosity is 80% or more, and the pore diameter is 40 to 80 nm.

For the flat separators, SUS, titanium material, carbon or the like can be used because they can play a role in electron conduction upon electrical generation. Especially, titanium material or the like has high corrosion resistance and is less in ion elution that can decrease the performance of fuel cells. As the flat separators used herein, it is preferable to use a titanium thin plate having a thickness of 50 to 800 μm.

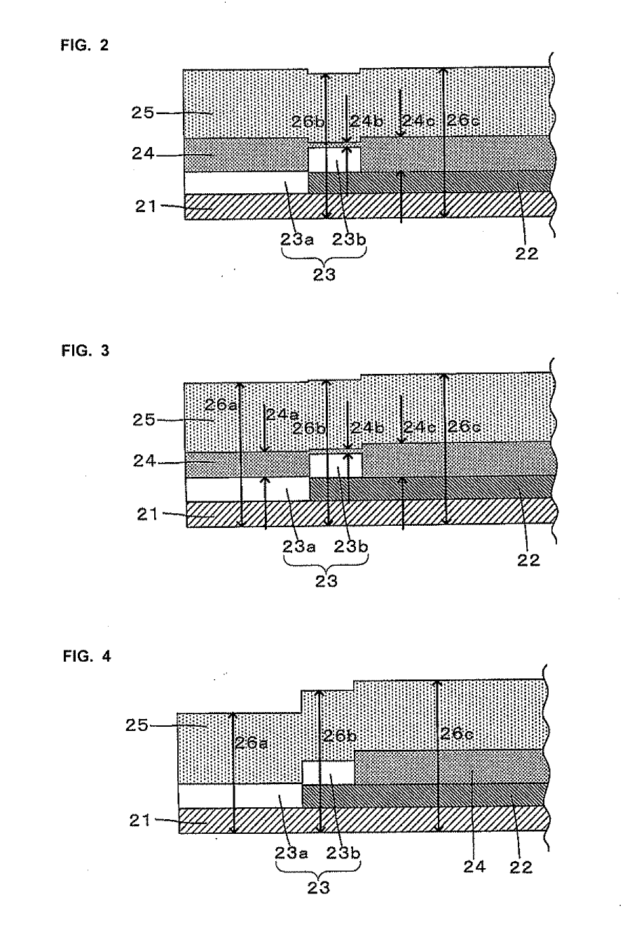

FIG. 2 is a schematic cross section showing a typical example the membrane electrode assembly according to the present invention, in which a single fuel cell thickness control layer is a water-repellent layer, and an electrode is provided only on one surface of an electrolyte membrane. More specifically, it is a view showing that in the state shown in FIG. 1(a), a gas diffusion layer 25 which has a water-repellent layer 24 that is provided on the catalyst layer 22 side of the gas diffusion layer 25 is further stacked on the catalyst layer 22 side. In this figure, the right half of the membrane electrode assembly is omitted; thus, in FIG. 2, the right end of the figure is the central region of the membrane electrode assembly, and the left end is the outer side in plane direction of the membrane electrode assembly.

As shown in FIG. 2, a frame-shaped protective layer is provided, which has a first part 23a that is present between the outer peripheral edge portion of the electrolyte membrane 21 and that of the gas diffusion layer 25 which face each other, and a second part 23b that overlaps the outer periphery of the catalyst layer 22.

In the central region where the protective layer 23 is not present, the water-repellent layer 24 is provided between the catalyst layer 22 and the gas diffusion layer 25; moreover, a thickness 24b of the water-repellent layer 24 in the region where the second part of the protective layer is present is made thinner than a thickness 24c of the same in the central region so that the thickness 26b of the membrane electrode assembly in the region where the second part 23b of the protective layer is present is equal to or smaller than the thickness 26c of the same in the central region where the protective layer 23 is not present. The thickness 24b can be 0, that is, it is possible that the water-repellent layer 24 is not present in the region where the second part of the protective layer is present. In this case, the water-repellent layer 24 is not present not only in the region where the second part 23b of the protective layer is present but also in the region where the first part 23a of the same is present.

Because of having such a structure, when a plurality of the completed single fuel cells in which an electrode is similarly provided on the other surface of the membrane electrode assembly and separators are further provided are stacked, the mechanical load applied to the electrolyte membrane can be suppressed, and a sufficient load is applied per unit area of the central region of the single fuel cell, thereby generating sufficient electricity as designed.

In the region where the second part 23b of the protective layer is present, the catalyst layer 22 is originally isolated from the gas diffusion layer 25 by the second part 23b of the protective layer. Consequently, in the region where the second part 23b of the protective layer is present, the gas supplied cannot reach the catalyst layer 22, thereby producing no water, which is a product of electrode reaction. Accordingly, even if the thickness of the water-repellent layer is, as mentioned above, controlled in the above region, there is no adverse effect on the water repellency of the whole completed single fuel cell.

FIG. 3 is a schematic cross section showing a second typical example of the membrane electrode assembly according to the present invention, in which a single fuel cell thickness control layer is a water-repellent layer, and an electrode is provided only on one surface of an electrolyte membrane. The structure of the polymer electrolyte membrane 21, catalyst layer 22, protective layer 23 and gas diffusion layer 25 is the same as the membrane electrode assembly shown in FIG. 2.

As shown in FIG. 3, each of a thicknesses 24a and the thickness 24b of the water-repellent layer in the region where the first part 23a and second part 23b of the protective layer are present is preferably thinner than the thickness 24c of the same in the central region so that thicknesses 26a and 26b of the membrane electrode assembly in the region where the first part 23a and second part 23b of the protective layer are present is equal to or smaller than the thickness 26c of the membrane electrode assembly in the central region where the protective layer is not present.

In the case where the thickness of the catalyst layer 22 is thicker than or substantially equal to that of the protective layer 23, the thicknesses 24a and 24c can be substantially equal to each other. This is because when the thickness of the catalyst layer 22 is thicker than or substantially equal to that of the protective layer 23, the thickness 26a is naturally equal to or smaller than the thickness 26c, thereby obtaining the advantageous effects of the present invention. The thicknesses 24a and 24b are values that are independent of each other, as well as the thicknesses 26a and 26b.

Also, the thickness 24a can be 0, that is, it is possible that the water-repellent layer 24 is not present in the region where the first part of the protective layer is present.

In the region where the first part 23a of the protective layer is present, the catalyst layer is not present, and thus the region is not involved in electrode reaction, thereby producing no water, which is a reaction product. Consequently, it is not necessary to make the thickness of the water-repellent layer in this region thicker than the thickness of the same in the central region of the single fuel cell. Accordingly, even if the thickness of the water-repellent layer is controlled as mentioned above, there is no adverse effect on the water repellency of the whole completed single fuel cell.

FIG. 4 is a schematic cross section showing a third typical example of the membrane electrode assembly according to the present invention, in which a single fuel cell thickness control layer is a water-repellent layer, and an electrode is provided only on one surface of an electrolyte membrane. The structure of the polymer electrolyte membrane 21, catalyst layer 22, protective layer 23 and gas diffusion layer 25 is the same as the membrane electrode assembly shown in FIG. 2.

As shown in FIG. 4, the water-repellent layer 24 is preferably not present in the region where the first part 23a and second part 23b of the protective layer are present. Because of having such a structure, the thicknesses 26a and 26b of the membrane electrode assembly in the region where the first part 23a and second part 23b of the protective layer are present can be equal to or smaller than the thickness 26c of the membrane electrode assembly in the central region where the protective layer is not present.

As mentioned above, it is not necessary to provide the water-repellent layer in the region where the first part 23a and second part 23b of the protective layer are present. Accordingly, even if the water-repellent layer is removed from the region, there is no adverse effect on the water repellency of the whole completed single fuel cell.

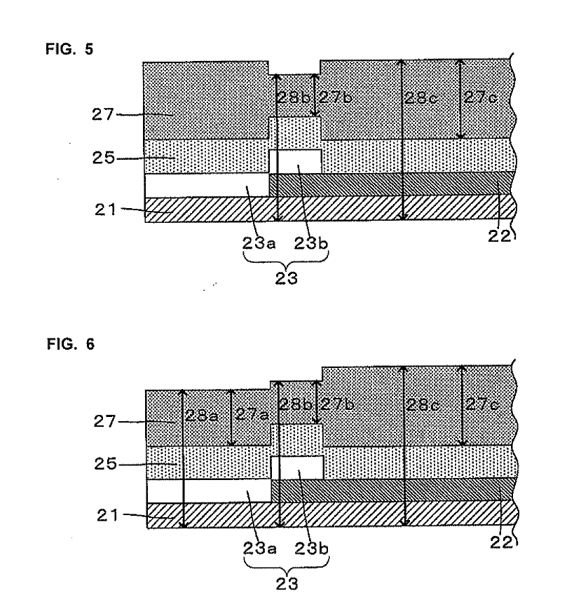

FIG. 5 is a schematic cross section showing a typical example in which a single fuel cell thickness control layer is a porous layer, and an electrode and the porous layer are provided only on one surface of an electrolyte membrane. More specifically, it is a view showing that in the state shown in FIG. 1(a), the gas diffusion layer 25 and a porous layer 27 are further stacked in this order on the catalyst layer 22 side. In this figure, the right half of the laminate is omitted; thus, in FIG. 5, the right end of the figure is the central region of the laminate, and the left end is the outer side in plane direction of the laminate. Also in FIG. 5, the water-repellent layer is a part of the gas diffusion layer or is not provided, so that the water-repellent layer is not shown herein purposefully.

As shown in FIG. 5, a frame-shaped protective layer is provided, which has the first part 23a that is present between the outer peripheral edge portion of the electrolyte membrane 21 and that of the gas diffusion layer 25 which face each other, and the second part 23b that overlaps the outer periphery of the catalyst layer 22.

The porous layer 27 in the region where the second part 23b of the protective layer is present is formed to be thinner than a thickness 28c of the same in the central region so that a thickness 28b of the laminate in the region where the second part 23b of the protective layer is present is equal to or smaller than the thickness 28c of the same in the central region where the protective layer 23 is not present. That is, 27b<27c so that 28b≦28c.

Because of having such a structure, when a plurality of the completed single fuel cells in which an electrode is similarly provided on the other surface of the membrane electrode assembly and separators are further provided are stacked, the mechanical load applied to the electrolyte membrane can be suppressed, and a sufficient load is applied per unit area of the central region of the single fuel cell, thereby generating sufficient electricity as designed.

In the region where the second part 23b of the protective layer is present, the catalyst layer 22 is originally isolated from the gas diffusion layer 25 by the second part 23b of the protective layer, so that the gas supplied cannot reach the catalyst layer 22. Consequently, in the region where the second part 23b of the protective layer is present, it is not necessary to make the thickness of the porous layer thicker than the thickness of the same in the central region of the single fuel cell. Accordingly, even if the thickness of the porous layer is controlled as mentioned above, there is no adverse effect on the gas supplying ability of the whole completed single fuel cell.

FIG. 6 is a schematic cross section showing a second typical example in which a single fuel cell thickness control layer is a porous layer, and an electrode and the porous layer are provided only on one surface of an electrolyte membrane. The structure of the polymer electrolyte membrane 21, catalyst layer 22, protective layer 23 and gas diffusion layer 25 is the same as the laminate shown in FIG. 5. Also in FIG. 6, because of the same reason as FIG. 5, the water-repellent layer is not shown herein purposefully.

As shown in FIG. 6, it is preferable that a thickness 27a and the thickness 27b of the porous layer in the region where the first part 23a and second part 23b of the protective layer are present are thinner than the thickness 27c of the same in the central region so that a thickness 28a and the thickness 28b of the laminate in the region where the first part 23a and second part 23b of the protective layer are present is equal to or smaller than the thickness 28c of the same in the central region where the protective layer is not present. That is, it is preferable that 27a<27c and 27b<27c so that 28a≦28c and 28b≦28c.

In the case where the thickness of the catalyst layer 22 is thicker than or substantially equal to that of the protective layer 23, the thicknesses 27a and 27c can be substantially equal to each other. This is because when the thickness of the catalyst layer 22 is thicker than or substantially equal to that of the protective layer 23, the thickness 28a is naturally equal to or smaller than the thickness 28c, thereby obtaining the advantageous effects of the present invention. The thicknesses 27a and 27b are values that are independent of each other, as well as the thicknesses 28a and 28b.

In the region where the first part of the protective layer is present, the catalyst layer is not present, and thus the region is not involved in electrode reaction. Consequently, it is not necessary to make the thickness of the porous layer in this region thicker than the thickness of the same in the central region of the single fuel cell purposefully. Accordingly, even if the thickness of the porous layer is controlled as mentioned above, there is no adverse effect on the gas supplying ability of the whole completed single fuel cell.

The water-repellent layer thickness control shown in FIGS. 2, 3 and 4, and the porous layer thickness control shown FIGS. 5 and 6 can be applied to any of the examples shown in FIG. 1s.

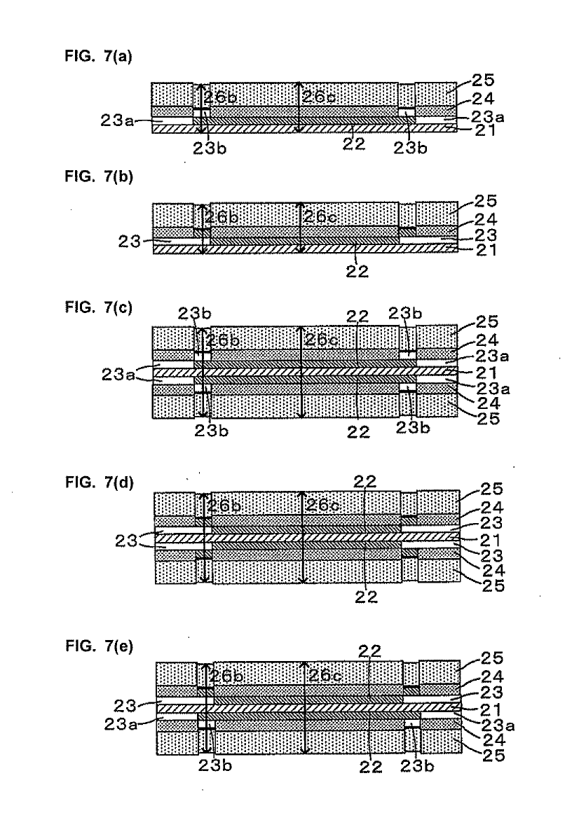

FIGS. 7s and Ss are schematic cross sections showing a membrane electrode assembly in which the water-repellent layer thickness control shown in FIG. 2 is applied to the examples shown in FIG. 1s. In these figures, as with FIG. 1s, layers which are identical in pattern are actually one continuous layer.

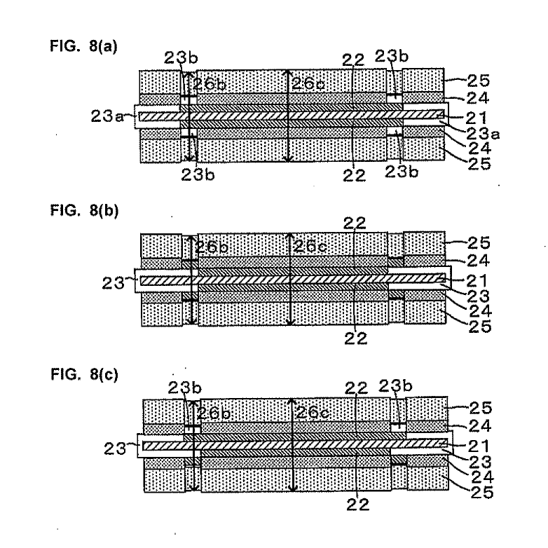

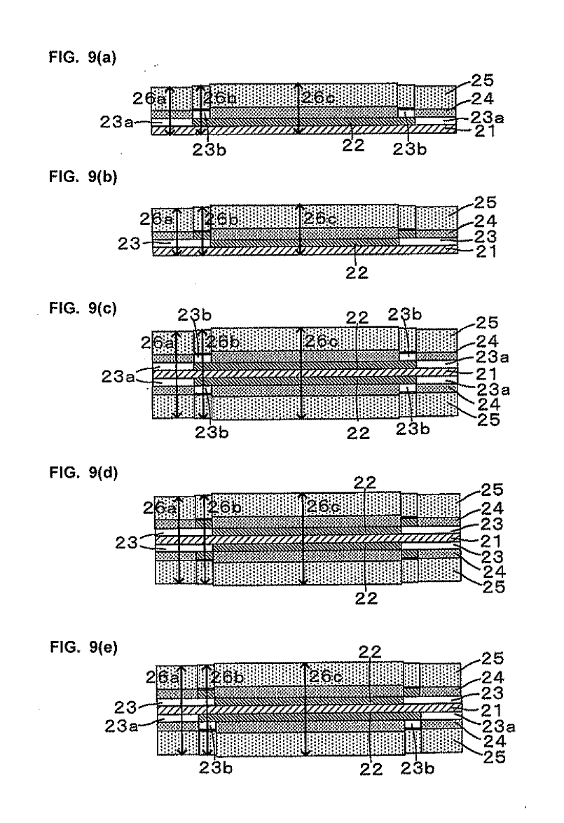

FIGS. 7(a) and 7(b) are schematic cross sections showing an example in which an electrode is provided on one surface of the electrolyte membrane 21. FIG. 7(a) is such that the water-repellent layer 24 subjected to the thickness control shown in FIG. 2 and the gas diffusion layer 25 are provided to the FIG. 1(a). In FIG. 7(b), the same layers are provided to the FIG. 1(b). The example shown in FIG. 7(a) is the same as that of FIG. 2. FIGS. 7(c) to 7(e) and 8(a) to 8(c) are schematic cross sections showing an example in which an electrode is provided on both surfaces of the electrolyte membrane 21 each. FIG. 7(c) is such that the water-repellent layer 24 subjected to the thickness control shown in FIG. 2 and the gas diffusion layer 25 are provided to FIG. 1(c). In FIGS. 7(d), 7(e), 8(a), 8(b) and 8(c), the water-repellent layer 24 subjected to the thickness control shown in FIG. 2 and the gas diffusion layer 25 are provided to FIGS. 1(d), 1(e), 1(f), 1(g) and 1(h), respectively.

In any of FIGS. 7(a) to 7(e) and 8(a) to 8(c), the thickness 26b of the membrane electrode assembly in the region where the second part 23b of the protective layer is present is equal to or smaller than the thickness 26c of the same in the central region where the protective layer 23 is not present, so that the single fuel cell produced by using any of these membrane electrode assemblies can have a structure in which the thickness of the single fuel cell in the region where the second part 23b of the protective layer 23 is present is equal to or smaller than the thickness of the same in the central region where the protective layer 23 is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

In FIGS. 7(a) and (b), an electrode having no protective layer can be provided on the other surface of the electrolyte membrane 21. In this case, it is not necessary to control the thickness of the water-repellent layer on the other surface, and it is possible to obtain the advantageous effects of the present invention only by controlling just the thickness of the water-repellent layer provided on the surface having the protective layer in the same manner as mentioned above.

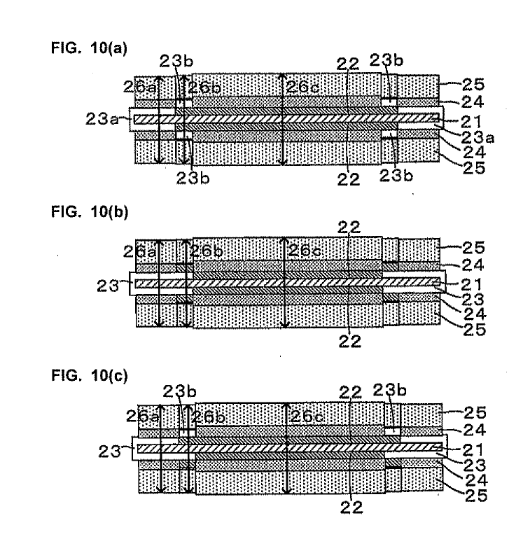

FIG. 9s and 10s are schematic cross sections showing a membrane electrode assembly in which the water-repellent layer thickness control shown in FIG. 3 is applied to the examples shown in FIG. 1s. In these figures, as with FIG. 1s, layers which are identical in pattern are actually one continuous layer.

FIGS. 9(a) and 9(b) are schematic cross sections showing an example in which an electrode is provided on one surface of the electrolyte membrane 21. FIG. 9(a) is such that the water-repellent layer 24 subjected to the thickness control shown in FIG. 3 and the gas diffusion layer 25 are provided to FIG. 1(a). In FIG. 9(b), the same layers are provided to the FIG. 1(b). The example shown in FIG. 9(a) is the same as that of FIG. 3. FIGS. 9(c) to 9(e) and 10(a) to 10(c) are schematic cross sections showing an example in which an electrode is provided on both surfaces of the electrolyte membrane 21 each. FIG. 9(c) is such that the water-repellent layer 24 subjected to the thickness control shown in FIG. 3 and the gas diffusion layer 25 are provided to FIG. 1(c). In FIGS. 9(d), 9(e), 10(a), 10(b) and 10(c), the water-repellent layer 24 subjected to the thickness control shown in FIG. 3 and the gas diffusion layer 25 are provided to FIGS. 1(d), 1(e), 1(f), 1(g) and 1(h), respectively.

In any of FIGS. 9(a) to 9(e) and 10(a) to 10(c), the thicknesses 26a and 26b of the membrane electrode assembly in the region where the first part 23a and second part 23b of the protective layer are present is equal to or smaller than the thickness 26c of the same in the central region where the protective layer is not present, so that the single fuel cell produced by using any of these membrane electrode assemblies can have a structure in which the thickness of the single fuel cell in the region where the first part 23a and second part 23b of the protective layer 23 are present is equal to or smaller than the thickness of the same in the central region where the protective layer 23 is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

In FIGS. 9(a) and 9(b), an electrode having no protective layer can be provided on the other surface of the electrolyte membrane 21. In this case, it is not necessary to control the thickness of the water-repellent layer on the other surface, and it is possible to obtain the advantageous effects of the present invention only by controlling just the thickness of the water-repellent layer provided on the surface having the protective layer in the same manner as mentioned above.

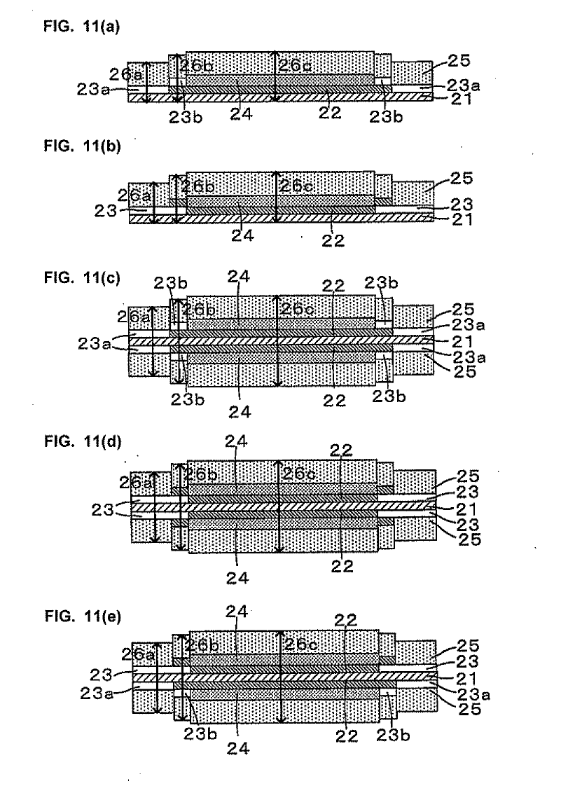

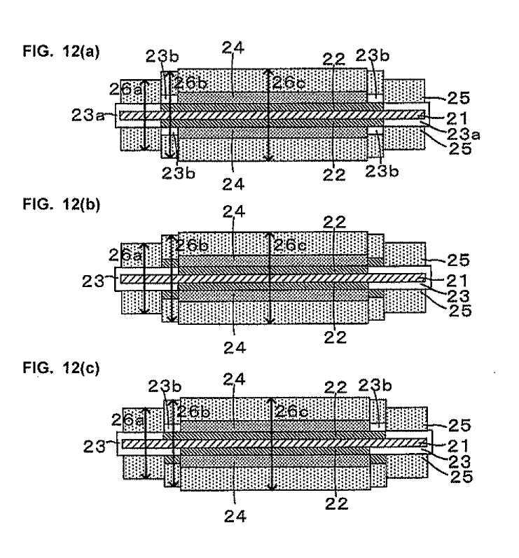

FIGS. 11s and 12s are schematic cross sections showing a membrane electrode assembly in which the water-repellent layer thickness control shown in FIG. 4 is applied to the example shown in FIG. 1s. In these figures, as with FIG. 1s, layers which are identical in pattern are actually one continuous layer.

FIGS. 11(a) and 11(b) are schematic cross section showing an example in which an electrode is provided on one surface of the electrolyte membrane 21.

FIG. 11(a) is such that the water-repellent layer 24 subjected to the thickness control shown in FIG. 4 and the gas diffusion layer 25 are provided to FIG. 1(a). In FIG. 11(b), the same layers are provided to FIG. 1(b). The example shown in FIG. 11(a) is the same as that of FIG. 4. FIGS. 11(c) to 11(e) and 12(a) to 12(c) are schematic cross sections showing an example in which an electrode is provided on both surfaces of the electrolyte membrane 21. FIG. 11(c) is such that the water-repellent layer 24 subjected to the thickness control shown in FIG. 4 and the gas diffusion layer 25 are provided to FIG. 1(c). In FIGS. 11(d), 11(e), 12(a), 12(b) and 12(c), the water-repellent layer 24 subjected to the thickness control shown in FIG. 4 and the gas diffusion layer 25 are provided to FIGS. 1(d), 1(e), 1(f), 1(g) and 1(h), respectively.

In any of FIGS. 11(a) to 11(e) and 12(a) to 12(c), the thicknesses 26a and 26b of the membrane electrode assembly in the region where the first part 23a and second part 23b of the protective layer are present is equal to or smaller than the thickness 26c of the same in the central region where the protective layer is not present, so that the single fuel cell produced by using any of these membrane electrode assemblies can have a structure in which the thickness of the single fuel cell in the region where the first part 23a and second part 23b of the protective layer 23 are present is equal to or smaller than the thickness of the same in the central region where the protective layer 23 is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

In FIGS. 11(a) and 11(b), an electrode having no protective layer can be provided on the other surface of the electrolyte membrane 21. In this case, it is not necessary to control the thickness of the water-repellent layer on the other surface, and it is possible to obtain the advantageous effects of the present invention only by controlling just the thickness of the water-repellent layer provided on the surface having the protective layer in the same manner as mentioned above.

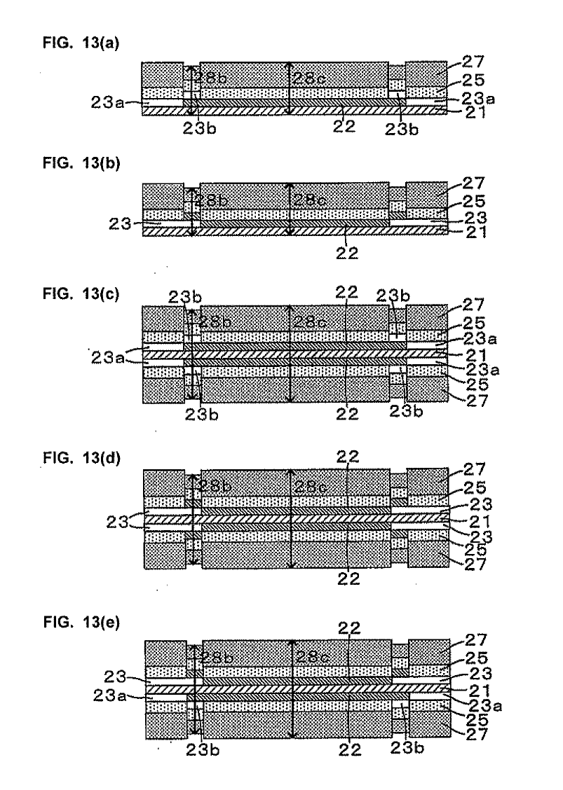

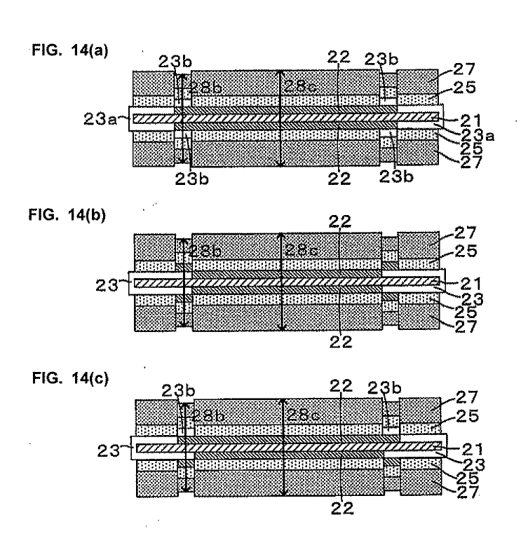

FIGS. 13s and 14s are schematic cross sections showing a laminate in which the porous layer thickness control shown in FIG. 5 is applied to the examples shown in FIG. 1s. In these figures, as with FIG. 1s, layers which are identical in pattern are actually one continuous layer.

FIGS. 13(a) and 13(b) are schematic cross sections showing an example in which an electrode and a porous layer are provided on one surface of the electrolyte membrane 21. FIG. 13(a) is such that the gas diffusion layer 25 and the porous layer 27 subjected to the thickness control shown in FIG. 5 are provided to FIG. 1(a). In FIG. 13(b), the same layers are provided to FIG. 1(b). The example shown in FIG. 13(a) is the same as that of FIG. 5. FIGS. 13(c) to 13 (e) and 14(a) to 14(c) are schematic cross sections showing an example in which an electrode and a porous layer are provided on both surfaces of the electrolyte membrane 21. In FIGS. 13(c), 13(d), 13(e), 14(a), 14(b) and 14(c), the gas diffusion layer 25 and the porous layer 27 subjected to the thickness control shown in FIG. 5 are provided to FIGS. 1(c), 1(d), 1(e), 1(f), 1(g) and 1(h), respectively.

In any of FIGS. 13(a) to 13(e) and 14(a) to 14(c), the thickness 28b of the laminate in the region where the second part 23b of the protective layer is present is equal to or smaller than the thickness 28c of the laminate in the central region where the protective layer 23 is not present, so that the single fuel cell produced by using any of these laminates can have a structure in which the thickness of the single fuel cell in the region where the second part 23b of the protective layer 23 is present is equal to or smaller than the thickness of the same in the central region where the protective layer 23 is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

In FIGS. 13(a) and 13(b), an electrode having no protective layer can be provided on the other surface of the electrolyte membrane 21. In this case, it is not necessary to control the thickness of the porous layer on the other surface, and it is possible to obtain the advantageous effects of the present invention only by controlling just the thickness of the porous layer provided on the surface having the protective layer in the same manner as mentioned above.

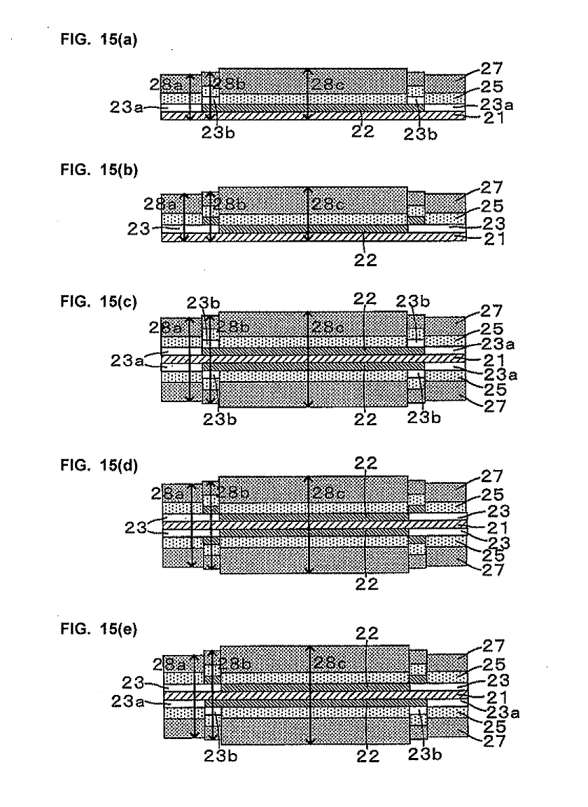

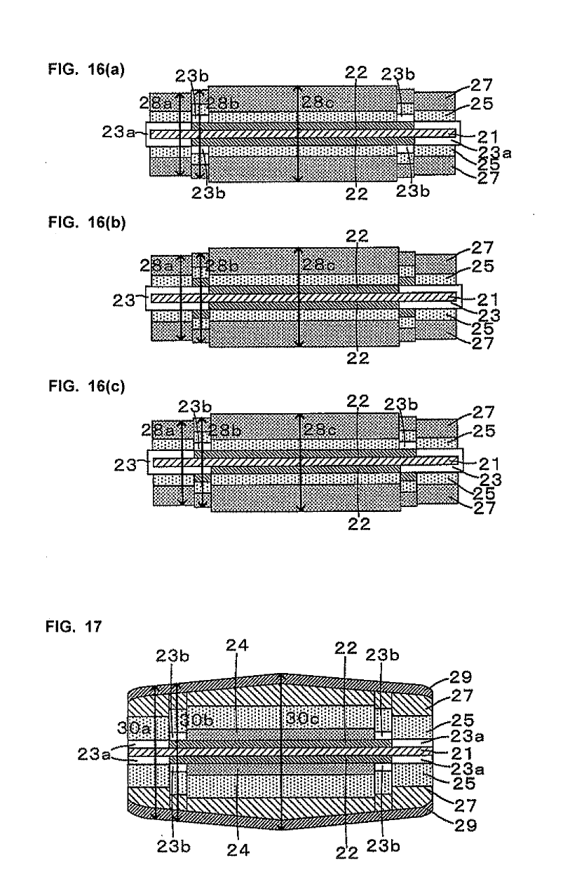

FIGS. 15s and 16s are schematic cross sections showing a laminate in which the porous layer thickness control shown in FIG. 6 is applied to the examples shown in FIG. 1s. In these figures, as with FIG. 1s, layers which are identical in pattern are actually one continuous layer.

FIGS. 15(a) and 15(b) are schematic cross sections showing an example in which an electrode and a porous layer are provided on one surface of the electrolyte membrane 21. FIG. 15(a) is such that the gas diffusion layer 25 and the porous layer 27 subjected to the thickness control shown in FIG. 6 are provided to FIG. 1(a). In FIG. 15(b), the same layers are provided to FIG. 1(b). The example shown in FIG. 15(a) is the same as that of FIG. 6. FIGS. 15(c) to 15(e) and 16(a) to 16(c) are schematic cross sections showing an example in which an electrode and a porous layer are provided on both surfaces of the electrolyte membrane 21. In FIGS. 15(c), 15(d), 15(e), 16(a), 16(b) and 16(c), the gas diffusion layer 25 and the porous layer 26 subjected to the thickness control shown in FIG. 6 are provided to FIGS. 1(c), 1(d), 1(e), 1(f), 1(g) and 1(h), respectively.

In any of FIGS. 15(a) to 15(e) and 16(a) to 16(c), the thicknesses 28a and 28b of the laminate in the region where the first part 23a and second part 23b of the protective layer are present is equal to or smaller than the thickness 28c of the same in the central region where the protective layer is not present, so that the single fuel cell produced by using any of these laminates can have a structure in which the thickness of the single fuel cell in the region where the first part 23a and second part 23b of the protective layer 23 are present is equal to or smaller than the thickness of the same in the central region where the protective layer 23 is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

In FIGS. 15(a) and 15(b), an electrode having no protective layer can be provided on the other surface of the electrolyte membrane 21. In this case, it is not necessary to control the thickness of the porous layer on the other surface, and it is possible to obtain the advantageous effects of the present invention only controlling just the thickness of the porous layer provided on the surface having the protective layer in the same manner as mentioned above.

Rather than the case where the protective layer is provided only on one surface, and the single fuel cell thickness control layer provided on the surface is subjected to thickness control, it is preferred that as shown in FIGS. 7(c) to 7(e), 8(a) to 8(c), 9(c) to 9(e), 10(a) to 10(c), 11(c) to 11(e), 12(a) to 12(c), 13(c) to 13(e), 14(a) to 14(c), 15(c) to 15(e) and 16(a) to 16(c), the electrodes on both surfaces have the protective layer and single fuel cell thickness control layer (in this case, water-repellent layer or porous layer) each, and the single fuel cell thickness control layer is thinner in the region where the second part of the protective layer is present than in the central region, or is not present so that in the region where the second part of the protective layer is present, the thickness of the membrane electrode assembly or that of the laminate having the membrane electrode assembly and porous layer is equal to or smaller than the thickness of the membrane electrode assembly or that of the laminate in the central region where the protective layer is not present. This is because in the completed single fuel cell, on any of the anode and cathode electrode sides, the mechanical load applied to the electrolyte membrane can be suppressed, and a sufficient load is applied per unit area of the central region of the single fuel cell, thereby obtaining the advantageous effects of the present invention.

It is preferable that when the single fuel cell thickness control layer is the water-repellent layer, the thickness of the water-repellent layer in the region of the single fuel cell where the first and second parts of the protective layer are present is equal to or smaller than the thickness of the protective layer. This is because it is possible to suppress the mechanical load applied to the electrolyte membrane and apply a sufficient load per unit area of the central region of the single fuel cell by choosing an appropriate thickness of the water-repellent layer in the region where the first and second parts of the protective layer are present.

It is preferable that when the single fuel cell thickness control layer is the water-repellent layer, the water-repellent layer is not present in the region of the single fuel cell where the first and second parts of the protective layer are present. This is because it is possible to suppress the mechanical load applied to the electrolyte membrane and apply a sufficient load per unit area of the central region of the single fuel cell by not providing the water-repellent layer which is essentially unnecessary in the outer edge portion of the anode or cathode catalyst layer.

It is preferable that the thickness of the porous layer is 200 to 600 μm in the region where the first and second parts of the protective layer are present.

Especially in consideration of the thickness of the protective layer, the thickness of the porous layer is preferably 200 to 500 μm in the region where the second part of the protective layer is present. This is because if the thickness of the porous layer exceeds 500 μm, the thickness of the single fuel cell in the region where the second part of the protective layer is present exceeds the thickness of the same in its central region, and if the thickness of the porous layer is less than 200 μm, it is not possible to maintain the thickness of the porous layer, which is sufficiently elastic to make the pressure that is applied to the membrane electrode assembly inside the single fuel cell constant. Furthermore, the thickness of the porous layer is preferably 200 to 400 μm in the region where the second part of the protective layer is present.

Also, especially in consideration of the thickness of the protective layer, the thickness of the porous layer is preferably 200 to 500 μm in the region where the first part of the protective layer is present. This is because if the thickness of the porous layer exceeds 500 μm, the thickness of the single fuel cell in the region where the first part of the protective layer is present exceeds the thickness of the same in its central region, and if the thickness of the porous layer is less than 200 μm, it is not possible to maintain the thickness of the porous layer, which is sufficiently elastic to make the pressure that is applied to the membrane electrode assembly inside the single fuel cell constant. Furthermore, the thickness of the porous layer is preferably 200 to 500 μm in the region where the first part of the protective layer is present.

The thickness of the porous layer in the central region where the protective layer is not present is preferably 300 to 600 μm. This is because it is a thickness which is sufficiently elastic to make the pressure that is applied to the membrane electrode assembly inside the single fuel cell constant.

FIG. 17 is a view showing a typical example of the single fuel cell according to the present invention. In FIG. 17, the deflection of the flat separators is overdrawn to emphasize the difference in thickness between the regions of the single fuel cell.

The single fuel cell of the typical example is formed by sandwiching the membrane electrode assembly shown in FIG. 11(c) between a pair of the porous layers 27 and further sandwiching the resulting sandwich between a pair of flat separators 29 each of which has no gas passage. The thickness of the porous layer 27 and that of the flat separators 29 are independent of the regions of the single fuel cell and substantially uniform; therefore, when sandwiched, each of the flat separators 29 bends due to the difference in thickness between the regions of the membrane electrode assembly. At this time, because of using the membrane electrode assembly in which the water-repellent layer 24 is not present in the region where the first part 23a and second part 23b of the protective layer are present, a structure can be obtained in which thicknesses 30a and 30b of the single fuel cell in the region where the first part 23a and second part 23b of the protective layer are present is equal to or smaller than a thickness 30c of the same in the central region where the protective layer is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

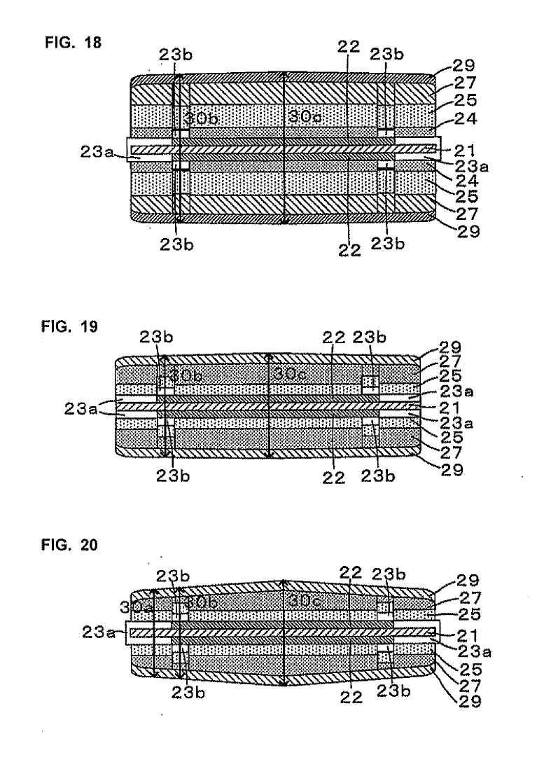

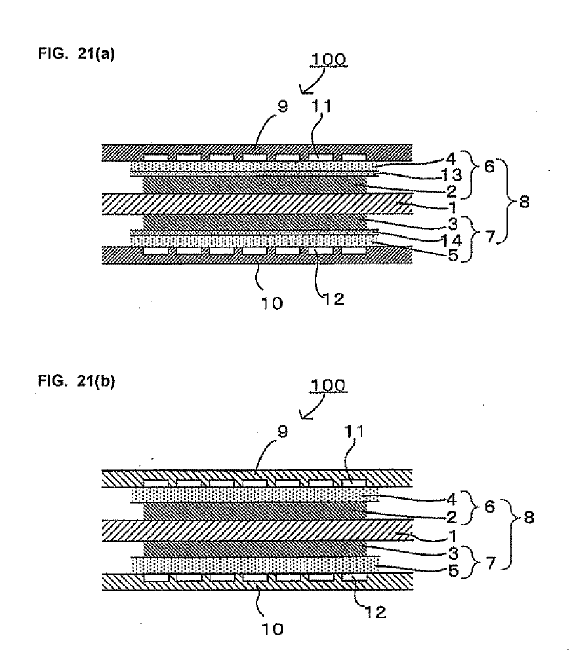

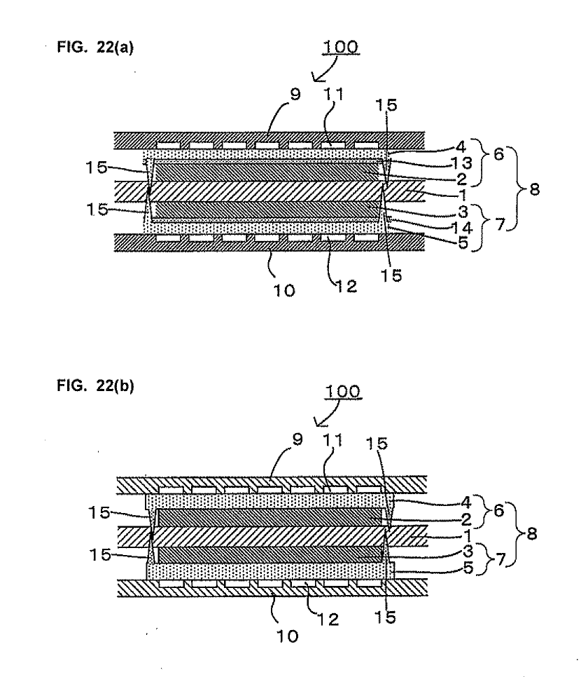

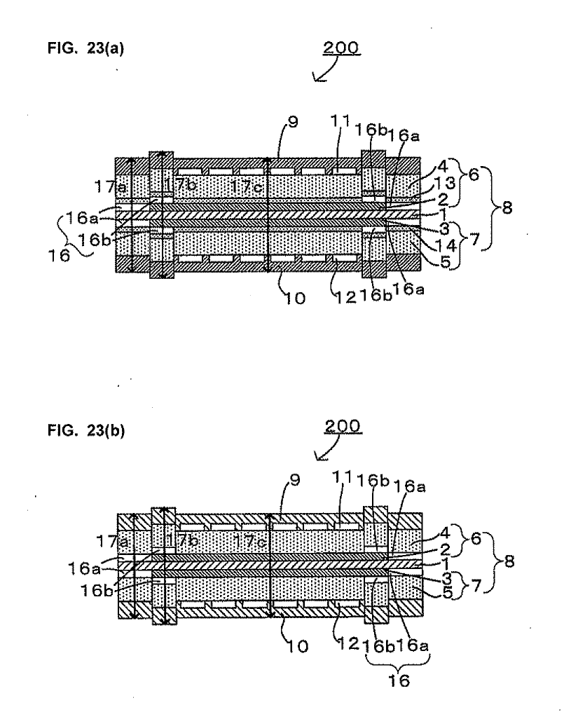

FIG. 18 is a view showing a second typical example of the single fuel cell according to the present invention. Also in FIG. 18, as with FIG. 17, the difference in thickness between the regions of the single fuel cell is overdrawn.

The single fuel cell of the second typical example is formed by sandwiching the membrane electrode assembly shown in FIG. 8(a) between a pair of the porous layers 27 and further sandwiching the resulting sandwich between a pair of the flat separators 29 each of which has no gas passage. In this case, because of using the membrane electrode assembly in which the thickness of the water-repellent layer 24 in the region where the second part 23b of the protective layer is present is thinner than the thickness of the same in the central region, a structure can be obtained in which the thickness 30b of the single fuel cell in the region where the second part 23b of the protective layer is present is equal to or smaller than the thickness 30c of the same in the central region where the protective layer is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

FIG. 19 is a view showing a third typical example of the single fuel cell according to the present invention. Also in FIG. 19, as with FIG. 17, the deflection of the flat separators is overdrawn to emphasize the difference in thickness between the regions of the single fuel cell.

The single fuel cell of the third typical example is formed by sandwiching the laminate shown in FIG. 13(c) between a pair of the flat separators 29 each of which has no gas passage. The thickness of the porous layer 27 in the outer periphery of the single fuel cell is decreased by shaving the same. The thickness of the flat separators 29 is independent of the regions of the single fuel cell and substantially uniform; therefore, when sandwiched, each of the flat separators 29 bends due to the difference in thickness between the regions of the laminate. At this time, because of using the laminate in which the thickness of the porous layer 27 in the region where the second part 23b of the protective layer is present is thinner than the thickness of the same in the central region, a structure can be obtained in which the thickness 30b of the single fuel cell in the region where the second part 23b of the protective layer is present is equal to or smaller than the thickness 30c of the same in the central region where the protective layer is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

FIG. 20 is a view showing a fourth typical example of the single fuel cell according to the present invention. Also in FIG. 20, as with FIG. 17, the deflection of the flat separators is overdrawn.

The single fuel cell of the fourth typical example is formed by sandwiching the laminate shown in FIG. 16(a) between a pair of the flat separators 29 each of which has no gas passage. The thickness of the porous layer 27 in the outer periphery of the single fuel cell is decreased by pressing the same. The thickness of the flat separators 29 is independent of the regions of the single fuel cell and substantially uniform; therefore, when sandwiched, each of the flat separators 29 bends due to the difference in thickness between the regions of the membrane electrode assembly. At this time, because of using the laminate in which the thickness of the porous layer 27 in the region where the first part 23a and second part 23b of the protective layer are present is thinner than the thickness of the same in the central region, a structure can be obtained in which the thicknesses 30a and 30b of the single fuel cell in the region where the first part 23a and second part 23b of the protective layer are present is equal to or smaller than the thickness 30c of the same in the central region where the protective layer is not present. Accordingly, when a plurality of the single fuel cells are stacked, the mechanical load applied to the electrolyte membrane can be suppressed, and a sufficient load is applied per unit area of the central region of the single fuel cell, thereby generating sufficient electricity as designed.

According to the present invention, to make the thickness of the single fuel cell in the region where the second part of the protective layer is present, which is such thick due to the presence of the protective layer, equal to or smaller than the thickness of the same in the central region where the protective layer is not present, the thickness of the single fuel cell thickness control layer in the region where the second part is present is thinner than the thickness of the same in the central region, or the single fuel cell thickness control layer is not provided in the region where the second part is present; therefore, when a plurality of the single fuel cells are stacked, the mechanical load applied to the electrolyte membrane can be suppressed, and a sufficient load is applied per unit area of the central region of the single fuel cell, thereby generating sufficient electricity as designed.

The method for producing a single fuel cell according to the present invention is a method for producing the above-mentioned single fuel cell of the present invention, which comprises a step of partially and selectively decreasing the thickness of at least one of the porous layers provided on the anode and cathode sides of the solid polymer electrolyte membrane by shaving or pressing a part of the porous layer which overlaps the region where the first and second parts of the protective layer are present.

The materials and forming methods used for the components of the single fuel cell, the solid polymer electrolyte membrane, catalyst layer, protective layer, gas diffusion layer, water-repellent layer and flat separator (excluding porous layer) are as described above. The materials for the porous layer are also as described above.

As the method for partially and selectively shaving the porous layer, there may be mentioned a method for processing the same by cutting with a general cutter or the like.

As the method for partially and selectively pressing the porous layer, there may be mentioned a method for processing the same by pressing at a predetermined load.

The single fuel cell of the present invention can be obtained by using the method for producing the single fuel fell of such a step. The thickness of the porous layer in the region where the first and second parts of the protective layer are present can be decreased by a simple method of shaving or pressing the porous layer in the region where the first and second parts of the protective layer are present.

1. A single fuel cell which comprises a membrane electrode assembly and a pair of separators, in which assembly an anode electrode that comprises an anode catalyst layer and a gas diffusion layer is provided on a first surface of a solid polymer electrolyte membrane, and a cathode electrode that comprises a cathode catalyst layer and a gas diffusion layer is provided on a second surface of the solid polymer electrolyte membrane,
wherein, on at least one of the anode and cathode sides of the solid polymer electrolyte membrane, the anode or cathode catalyst layer has a size and shape that are slightly smaller than those of the solid polymer electrolyte membrane and those of the gas diffusion layer, and an outer peripheral edge portion of the solid polymer electrolyte membrane and that of the gas diffusion layer stick out of an outer periphery of the anode or cathode catalyst layer and face each other;
wherein a frame-shaped protective layer is provided on at least one of the anode and cathode sides of the solid polymer electrolyte membrane, which has a first part that is present between the outer peripheral edge portion of the electrolyte membrane and that of the gas diffusion layer which face each other, and a second part that overlaps the outer periphery of the anode or cathode catalyst layer; and
wherein the single fuel cell comprises a single fuel cell thickness control layer which is thinner in a region of the single fuel cell where the second part of the protective layer is present than in a central region of the single fuel cell where the protective layer is not present, or is not present in the region where the second part of the protective layer is present so that the thickness of the single fuel cell in the region where the second part of the protective layer is present is equal to or smaller than the thickness of the same in the central region where the protective layer is not present.

2. The single fuel cell according to claim 1, wherein the single fuel cell thickness control layer is a water-repellent layer that is present between the anode or cathode catalyst layer and the gas diffusion layer.

3. The single fuel cell according to claim 1, wherein the single fuel cell thickness control layer is at least one of porous layers between which the membrane electrode assembly is sandwiched, and the resulting sandwich is further sandwiched between a pair of flat separators each of which has no gas passage.

4. The single fuel cell according to claim 1, wherein, on both of the anode and cathode sides of the solid polymer electrolyte membrane, the single fuel cell thickness control layer is thinner in the region of the single fuel cell where the second part of the protective layer is present than in the central region of the same where the protective layer is not present, or is not present in the region where the second part of the protective layer is present so that the thickness of the single fuel cell in the region where the second part of the protective layer is present is equal to or smaller than the thickness of the same in the central region where the protective layer is not present.

5. The single fuel cell according to claim 1, wherein, on at least one of the anode and cathode sides of the solid polymer electrolyte membrane, the single fuel cell thickness control layer is thinner in the region of the single fuel cell where the first and second parts of the protective layer are present than in the central region of the same where the protective layer is not present, or is not present in the region where the first and second parts of the protective layer are present so that the thickness of the single fuel cell in the region where the first and second parts of the protective layer are present is equal to or smaller than the thickness of the same in the central region where the protective layer is not present.

6. The single fuel cell according to claim 2, wherein when the single fuel cell thickness control layer is the water-repellent layer, the membrane electrode assembly is sandwiched between a pair of porous layers, and the resulting sandwich is further sandwiched between a pair of flat separators each of which has no gas passage.

7. The single fuel cell according to claim 3, wherein each of the porous layers has a porosity of 70% or more and a pore diameter of 20 to 100 nm.

8. The single fuel cell according to claim 2, wherein when the single fuel cell thickness control layer is the water-repellent layer, the thickness of the water-repellent layer in the region of the single fuel cell where the first and second parts of the protective layer are present is equal to or smaller than the thickness of the protective layer.

9. The single fuel cell according to claim 2, wherein when the single fuel cell thickness control layer is the water-repellent layer, the water-repellent layer is not present in the region of the single fuel cell where the first and second parts of the protective layer are present.

10. The single fuel cell according to claim 3, wherein the thickness of the porous layer is 200 to 600 μm in the region where the first and second parts of the protective layer are present.

11. A method for producing the single fuel cell defined in claim 5, which method comprises a step of partially and selectively decreasing the thickness of at least one of the porous layers provided on the anode and cathode sides of the solid polymer electrolyte membrane by shaving or pressing a part of the porous layer which overlaps the region where the first and second parts of the protective layer are present.

12. The single fuel cell according to claim 6, wherein each of the porous layers has a porosity of 70% or more and a pore diameter of 20 to 100 nm.

13. A method for producing the single fuel cell defined in claim 3, which method comprises a step of partially and selectively decreasing the thickness of at least one of the porous layers provided on the anode and cathode sides of the solid polymer electrolyte membrane by shaving or pressing a part of the porous layer which overlaps the region where the second part of the protective layer are present.
